(19) United States
(12) Patent Application Publication
(10) Pub. No.: US 2019/0136802 A1
(43) Pub. Date: May 9, 2019

(54) Method and Device for Adjusting the Mass Flow of an Exhaust Gas Recirculation Valve

(71) Applicant: Continental Automotive GmbH, Hannover (DE)

(72) Inventor: Richard Kopold, Donaustauf (DE)

(73) Assignee: Continental Automotive GmbH, Hannover (DE)

(21) Appl. No.: 16/094,781

(22) PCT Filed: Apr. 3, 2017
(86) PCT No.: PCT/EP2017/057824

§ 371 Date: Oct. 18, 2018

(30) Foreign Application Priority Data
Apr. 19, 2016 (DE) 10 2016 206 554.8

(51) Int. Cl. F02M 26/64; F02D 41/00; F02D 43/04; F02D 9/02; F02D 41/14

(52) U.S. Cl. CPC F02M 26/64; F02D 41/0007; F02D 41/0065; F02D 43/04; F02D 2250/34; F02D 41/1401; F02D 2009/0276; F02D 2041/0017; F02D 2041/1434; F02D 9/02

(57) ABSTRACT

Various embodiments include a method for adjusting a mass flow through an exhaust-gas recirculation valve mechanically coupled to a throttle flap of an internal combustion engine which has a turbocharger comprising: determining a first setpoint value corresponding to a setpoint opening position of the exhaust-gas recirculation valve; determining a second setpoint value corresponding to a setpoint opening position of the throttle flap; comparing the first setpoint value to the second setpoint value; adjusting the mass flow of the exhaust-gas recirculation valve by varying an opening position of the exhaust-gas recirculation valve if the first setpoint value is higher than the second setpoint value; and adjusting the mass flow of the exhaust-gas recirculation valve by varying an opening position of the throttle flap if the second setpoint value is higher than the first setpoint value.

### CROSS-REFERENCE TO RELATED APPLICATIONS

This application is a U.S. National Stage Application of International Application No. PCT/EP2017/057824 filed Apr. 3, 2017, which designates the United States of America, and claims priority to DE Application No. 10 2016 206 554.8 filed Apr. 19, 2016, the contents of which are hereby incorporated by reference in their entirety.

### TECHNICAL FIELD

The present disclosure relates to internal combustion engines. Various embodiments may include a method and a device for adjusting the mass flow of an exhaust-gas recirculation valve of an internal combustion engine which has a turbocharger.

### BACKGROUND

To control an internal combustion engine, a composition of the gas charge and a filling of the combustion chamber with the gas charge are influenced in targeted fashion through setting of actuators such as throttle flaps, exhaust-gas recirculation valves, exhaust-gas flaps, etc. Both the composition and the quantity of the gas charge of the combustion chamber determine not only the amount of injected fuel but also the torque and the combustion products and thus the pollutant quantities in the exhaust gas. The majority of gasoline engines are operated with a stoichiometric combustion gas mixture. This, in conjunction with a three-way catalytic converter, permits an effective reduction of the pollutants formed during the combustion.

The fuel quantity to be injected is in this case determined by the air quantity present in the combustion chamber. In the case of a diesel engine, in nominal operation, the air quantity present constitutes a limitation for the fuel quantity to be injected, in order to achieve that the quantity of exhaust-gas particles remains limited. The oxygen concentration is a significant parameter for the generation of nitrogen oxides as a result of the combustion. A reduction of the oxygen concentration of the cylinder charge leads to a reduction in nitrogen oxide emissions.

In modern diesel engines, this is realized by means of exhaust-gas recirculation. This exhaust-gas recirculation may be realized internally through the cylinder of the internal combustion engine, or externally together with a cooling arrangement that may be provided. This external exhaust-gas recirculation may be performed upstream or downstream of the compressor of a turbocharger of the internal combustion engine. The terms “low-pressure exhaust-gas recirculation” or “high-pressure exhaust-gas recirculation” are correspondingly used.

A prerequisite for exhaust-gas recirculation is always that the gas pressure at the branching point is higher than that at the introduction point. In particular in the case of low-pressure exhaust-gas recirculation, this is not adequately possible in all situations. For this reason, to support the exhaust-gas recirculation, additional throttle flaps are installed in order to permit a required increase or a lowering of the gas pressure at the branching point or at the introduction point.

DE 10 2013 209 815 B3 describes a method and a system for controlling an internal combustion engine which is equipped with an exhaust-gas turbocharger and which furthermore has a high-pressure exhaust-gas recirculation arrangement and a low-pressure exhaust-gas recirculation arrangement. Here, on the basis of a physical model, a determination of flow parameters of the gas flow flowing in the system at different points of the gas flow is performed in a manner dependent on a position of an actuating element in the gas flow. These flow parameters include a temperature and/or a pressure. On the basis of the inverted physical model, a position of the actuating element corresponding to a predetermined flow parameter in the cylinder is determined, the actuating element is controlled into the determined position, a deviation of the predetermined flow parameter from the flow parameter of the gas flow in the cylinder is determined, and a calibration of the physical model is performed on the basis of the deviation, wherein the physical model comprises a recirculation of combusted gas into the cylinder, and wherein, furthermore, the flow parameter comprises a gas composition or a gas flow rate of the gas flow in the cylinder. By means of these measures, it is sought to achieve more direct or more exact control of the internal combustion engine.

### SUMMARY

The teachings of the present disclosure may be embodied in a method and/or a device for adjusting the mass flow flowing through the exhaust-gas recirculation valve of an internal combustion engine, which method and device operate in a stable manner during the operation of the internal combustion engine. For example, some embodiments include a method for adjusting the mass flow of an exhaust-gas recirculation valve, which is mechanically coupled to a throttle flap, of an internal combustion engine which has a turbocharger, having the following steps: ascertaining a first setpoint value which corresponds to a setpoint opening position of the exhaust-gas recirculation valve, ascertaining a second setpoint value which corresponds to a setpoint opening position of the throttle flap, comparing the first setpoint value with the second setpoint value; adjusting the mass flow of the exhaust-gas recirculation valve by means of a variation of the opening position of the exhaust-gas recirculation valve if the first setpoint value is higher than the second setpoint value, and adjusting the mass flow of the exhaust-gas recirculation valve by means of a variation of the opening position of the throttle flap if the second setpoint value is higher than the first setpoint value.

In some embodiments, the first setpoint value, which corresponds to the setpoint opening position of the exhaust-gas recirculation valve, is ascertained in accordance with the following relationship:

$${s}_{EGR , SP} = {A}_{EGR}^{- 1} ( \frac{{\dot{m}}_{EGR , SP}}{{g}_{EGR} ( {e}_{vor EGR} , {e}_{nach EGR} )} ) ,$$

where s_{EGR,SP} is the setpoint position of the exhaust-gas recirculation valve, A_{EGR}⁻¹ is the inverse function for the effective opening cross section of the exhaust-gas recirculation valve, \dot{m}_{EGR,SP} is the setpoint mass flow through the exhaust-gas recirculation valve, and g_{EGR}(e_{vorEGR},e_{nachEGR}) is a function of the gas characteristics upstream and downstream of the exhaust-gas recirculation valve.

In some embodiments, the second setpoint value, which corresponds to the setpoint opening position of the throttle flap, is ascertained in accordance with the following relationship:

$${s}_{THR , SP} = {A}_{THR}^{- 1} ( \frac{{\dot{m}}_{THR , SP}}{{g}_{THR} ( {e}_{vor THR} , {e}_{nach THR , SP} )} ) ,$$

where S_{THR,SP} is the setpoint position of the throttle flap, A_{THR}⁻¹ is the inverse function for the effective opening cross section of the throttle flap, \dot{m}_{THR,SP} is the setpoint mass flow through the throttle flap, and a g_{THR}(e_{vorTHR}, e_{nachTHR}) is a function of the gas characteristics upstream and downstream of the throttle flap.

In some embodiments, for the ascertainment of the second setpoint value, firstly a pressure setpoint value is determined on the basis of the model of the exhaust-gas recirculation valve, and subsequently the setpoint position of the throttle flap is determined on the basis of the model of the throttle flap.

In some embodiments, for the ascertainment of the second setpoint value, firstly the relationship

\dot{m}_{EGR,SP}=A_{EGR}(s_{EGR,SP})g_{EGR}(e_{vor EGR},e_{nach EGR})
is used to determine the pressure setpoint value downstream of the exhaust-gas recirculation valve, and the determined pressure setpoint value is used for determining the second setpoint value.

As another example, some embodiments include a device for adjusting the mass flow of an exhaust-gas recirculation valve, which is mechanically coupled to a throttle flap, of an internal combustion engine which has a turbocharger, characterized in that said device has a control unit (188) which is designed to control a method as described above.

### BRIEF DESCRIPTION OF THE DRAWINGS

Further characteristics of various embodiments of the teachings herein will emerge from the exemplary explanation thereof below on the basis of the figures. In the figures:

FIG. 1 shows a block illustration of an internal combustion engine equipped with an exhaust-gas turbocharger, with a low-pressure exhaust-gas recirculation arrangement and with a high-pressure exhaust-gas recirculation arrangement, incorporating teachings of the present disclosure;

FIG. 2 shows a block illustration of an internal combustion engine equipped with an exhaust-gas turbocharger, with a low-pressure exhaust-gas recirculation arrangement and with a high-pressure exhaust-gas recirculation arrangement, incorporating teachings of the present disclosure;

FIG. 3 shows a diagram for illustrating the effective opening cross-sectional area of an exhaust-gas recirculation valve as a function of the opening position of the exhaust-gas recirculation valve, incorporating teachings of the present disclosure; and

FIG. 4 shows a diagram for illustrating the effective opening cross-sectional area of a throttle flap, which is mechanically coupled to the exhaust-gas recirculation valve, as a function of the opening position of the exhaust-gas recirculation valve, incorporating teachings of the present disclosure.

### DETAILED DESCRIPTION

In some embodiments, a method for adjusting the mass flow of an exhaust-gas recirculation valve, which is mechanically coupled to a throttle flap, of an internal combustion engine which has a turbocharger, includes:
ascertaining a first setpoint value which corresponds to a setpoint opening position of the exhaust-gas recirculation valve,
ascertaining a second setpoint value which corresponds to a setpoint opening position of the throttle flap,
comparing the first setpoint value with the second setpoint value;
adjusting the mass flow of the exhaust-gas recirculation valve by means of a variation of the opening position of the exhaust-gas recirculation valve if the first setpoint value is higher than the second setpoint value, and
adjusting the mass flow of the exhaust-gas recirculation valve by means of a variation of the opening position of the throttle flap if the second setpoint value is higher than the first setpoint value.

By means of this approach, in the presence of an exhaust-gas recirculation valve mechanically coupled to a throttle flap, the coupled system composed of throttle flap and exhaust-gas recirculation valve may be activated in a stable manner. Here, the throttle flap and the exhaust-gas recirculation valve are characterized in model-based fashion independently of one another. A direct determination of the mass flow flowing via the exhaust-gas recirculation valve is possible, and the activation is automatically adapted in the event of a variation of the setpoint value. This may be useful in particular in the presence of different operating modes of the internal combustion engine.

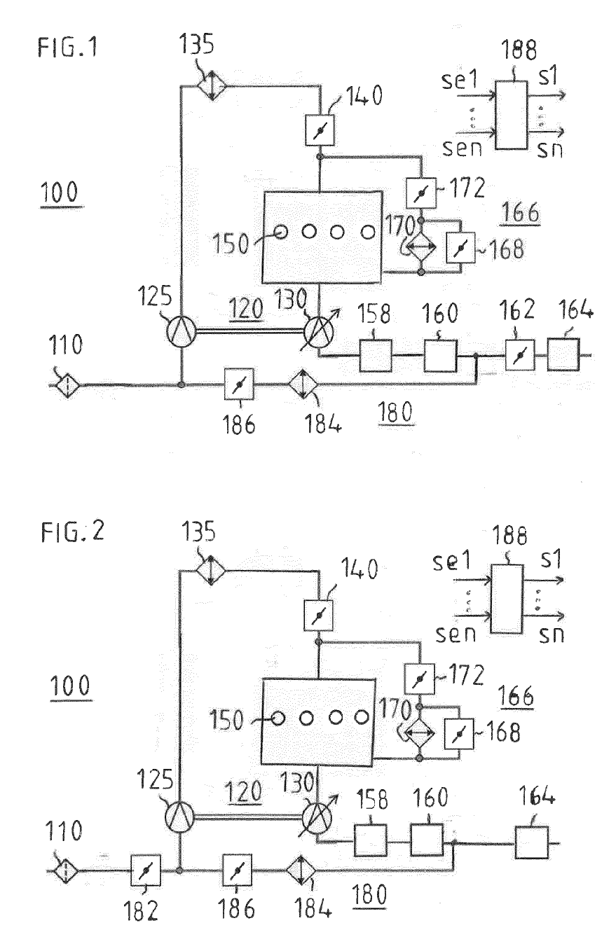

FIG. 1 shows a block illustration of an internal combustion engine equipped with an exhaust-gas turbocharger, with a low-pressure exhaust-gas recirculation arrangement and with a high-pressure exhaust-gas recirculation arrangement, incorporating teachings of the present disclosure.

In some embodiments, internal combustion engine 100 has a turbocharger 120, which includes an exhaust-gas turbine 130 and a compressor 125. The exhaust-gas turbine 130 is supplied with exhaust gas which is provided from the cylinders 150 of the internal combustion engine 100. Said exhaust gas causes the turbine wheel of the exhaust-gas turbine 130 to be set in rotation. This rotation of the turbine wheel is transmitted via a shaft of the exhaust-gas turbocharger to a compressor wheel of the compressor 125, which is thereby likewise set in rotation. The compressor wheel is provided for compressing a gas mixture which is composed of fresh air and of exhaust gas recirculated via a low-pressure exhaust-gas recirculation arrangement 180. Said fresh air is supplied to the compressor wheel via an air filter 110. The exhaust gas discharged from the exhaust-gas turbine 130 is released to the surroundings via a catalytic converter 158, a particle filter 160, an exhaust-gas flap 162, and a silencer 164.

In some embodiments, between the particle filter 160 and the exhaust-gas flap 162, there is a branching point at which exhaust gas is branched off, which exhaust gas is supplied via the low-pressure exhaust-gas recirculation arrangement 180 to the compressor 125. A cooler 184 and a low-pressure exhaust-gas recirculation valve 186 are provided in said low-pressure exhaust-gas recirculation arrangement 180. The compressed gas mixture is supplied from the outlet of the compressor 125 via a charge-air cooler 135 and a throttle 140 to the cylinders 150 of the internal combustion engine 100.

Furthermore, the internal combustion engine 100 shown in FIG. 1 has a high-pressure exhaust-gas recirculation arrangement 166. The latter is connected directly to an outlet of the cylinders 150, and is supplied with highly pressurized exhaust gas via said outlet. Said highly pressurized exhaust gas is conducted via a cooler 170 and a high-pressure exhaust-gas recirculation valve 172 to the inlet of the cylinders 150, in order to supply recirculated exhaust gas to said cylinders. Arranged in parallel with the cooler 170 is a bypass flap 168, for the purposes of making it possible for the cooler 170 to be bypassed when required.

Furthermore, the internal combustion engine 100 illustrated in FIG. 1 has a control unit 188. Sensor signals se1, . . . , sen provided by a multiplicity of sensors are supplied to said control unit 188. Evaluating said sensor signals and a working program stored in a memory (not illustrated) and stored tables and characteristic maps and physical models, the control unit 188 ascertains control signals s1, . . . , sn for the actuating elements of the internal combustion engine. Said actuating elements include inter alia the low-pressure exhaust-gas recirculation valve 186 and the exhaust-gas flap 162. The physical models include a model of the low-pressure exhaust-gas recirculation valve 186, and a model of the exhaust-gas flap 162, which forms a throttle point.

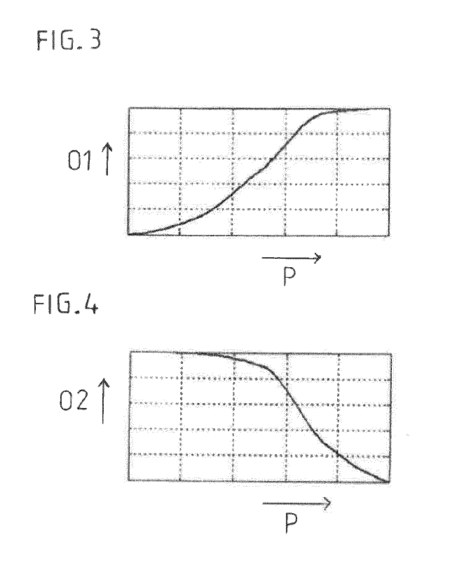

In some embodiments, the low-pressure exhaust-gas recirculation valve 186 and the exhaust-gas flap 162 may be mechanically coupled to one another and can be activated by means of the same control signal. This activation is performed in model-based fashion, as will be discussed in more detail below on the basis of FIGS. 3 and 4.

FIG. 2 shows a block illustration of an internal combustion engine equipped with an exhaust-gas turbocharger, with a low-pressure exhaust-gas recirculation arrangement and with a high-pressure exhaust-gas recirculation arrangement, incorporating teachings of the present disclosure.

Said internal combustion engine 100 has a turbocharger 120, which includes an exhaust-gas turbine 130 and a compressor 125. The exhaust-gas turbine 130 is supplied with exhaust gas which is provided from the cylinders 150 of the internal combustion engine 100. Said exhaust gas causes the turbine wheel of the exhaust-gas turbine to be set in rotation. This rotation of the turbine wheel is transmitted via a shaft of the exhaust-gas turbocharger to the compressor wheel of the compressor 125, which is thereby likewise set in rotation. The compressor wheel compresses a gas mixture which is composed of fresh air and of exhaust gas recirculated via a low-pressure exhaust-gas recirculation arrangement 180. Said fresh air is supplied to the compressor wheel via an air filter 110 and a throttle flap 182. The exhaust gas discharged from the exhaust-gas turbine 130 is released to the surroundings via a catalytic converter 158, a particle filter 160, and a silencer 164.

In some embodiments, between the particle filter 160 and the silencer 164, there is a branching point at which exhaust gas is branched off, which exhaust gas is supplied via the low-pressure exhaust-gas recirculation arrangement 180 to the compressor 125. A cooler 184 and a low-pressure exhaust-gas recirculation valve 186 are provided in said low-pressure exhaust-gas recirculation arrangement 180. The compressed gas mixture is supplied from the outlet of the compressor 125 via a charge-air cooler 135 and a throttle 140 to the cylinders 150 of the internal combustion engine 100.

Furthermore, the internal combustion engine 100 shown in FIG. 2 has a high-pressure exhaust-gas recirculation arrangement 166. The latter is connected directly to an outlet of the cylinders 150 and is supplied with highly pressurized exhaust gas via said outlet. Said highly pressurized exhaust gas is recirculated via a cooler 170 and a high-pressure exhaust-gas recirculation valve 172 to the inlet of the cylinders 150, in order to supply recirculated exhaust gas to said cylinders. Arranged in parallel with the cooler 170 is a bypass flap 168, for the purposes of making it possible for the cooler 170 to be bypassed when required.

Furthermore, the internal combustion engine 100 illustrated in FIG. 2 has a control unit 188. Sensor signals se1, . . . , sen provided by a multiplicity of sensors are supplied to said control unit 188. Evaluating said sensor signals and a working program stored in a memory (not illustrated) and stored tables and characteristic maps and physical models, the control unit 188 ascertains control signals s1, . . . , sn for the actuating elements of the internal combustion engine 100. Said actuating elements include inter alia the low-pressure exhaust-gas recirculation valve 186 and the throttle flap 182. The physical models include a model of the low-pressure exhaust-gas recirculation valve 186, and a model of the throttle flap 182, which forms a throttle point.

The low-pressure exhaust-gas recirculation valve 186 and the throttle flap 182 are advantageously mechanically coupled to one another and can be activated by means of the same control signal. This activation is performed in model-based fashion.

Such a model-based activation of a valve or of a throttle utilizes the known relationship between the gas mass flow and the position or setting of the valve or of the throttle in the presence of known gas characteristics such as temperature, pressure and gas composition upstream and downstream of the valve or of the throttle. For the modelling, it is possible for either the valve on its own or the entire exhaust-gas recirculation path together, to be considered. In general, the dependency of the gas mass flow factorizes into a dependency on the gas characteristics upstream and downstream of the valve and a dependency on the setting of the valve itself, such that the model is given by an equation in the form

\dot{m}=A(s)·g(eᵥₒᵣ,e_{nach})

where \dot{m} is the exhaust-gas mass flow, A(s) is the effective opening cross section and g(eᵥₒᵣ,e_{nach}) is a function of the gas characteristics upstream and downstream of the valve. This applies both to the throttle and to the exhaust-gas recirculation valve.

In the case of a separate activation of the exhaust-gas recirculation valve and of the throttle, the throttle may be utilized for adjusting a desired pressure drop across the exhaust-gas recirculation valve or the exhaust-gas recirculation path, and the exhaust-gas recirculation valve may be used for adjusting the desired exhaust-gas recirculation mass flow.

For the situation of throttling on the fresh air side, as shown in FIG. 2, the setpoint position of the exhaust-gas recirculation valve is obtained from the following relationship:

$${s}_{EGR , SP} = {A}_{THR}^{- 1} ( \frac{{\dot{m}}_{EGR , SP}}{{g}_{EGR} ( {e}_{vor EGR ,} {e}_{nach EGR} )} ) . \qquad ( 1 )$$

Here,

s_{EGR,SP} is the setpoint position of the exhaust-gas recirculation valve,
A_{EGR}⁻¹ is the inverse function for the effective opening cross section of the exhaust-gas recirculation valve,
\dot{m}_{EGR,SP} is the setpoint mass flow through the exhaust-gas recirculation valve, and
g_{EGR}(e_{vorEGR}, e_{nachEGR}) is a function of the gas characteristics upstream and downstream of the exhaust-gas recirculation valve.

For the situation of throttling on the fresh air side, as shown in FIG. 2, the setpoint position of the throttle flap 182 is obtained from the following relationship:

$${s}_{THR , SP} = {A}_{THR}^{- 1} ( \frac{{\dot{m}}_{THR , SP}}{{g}_{THR} ( {e}_{vor THR ,} {e}_{nach THR , SP} )} ) . \qquad ( 2 )$$

Here,

s_{THR,SP} is the setpoint position of the throttle flap,
A_{THR}⁻¹ is the inverse function for the effective opening cross section of the throttle flap,
\dot{m}_{THR,SP} is the setpoint mass flow through the throttle flap, and
g_{THR}(e_{vorTHR},e_{nachTHR}) is a function of the gas characteristics upstream and downstream of the throttle flap.

In the case of a joint activation of the exhaust-gas recirculation valve and of the throttle flap, owing to the mechanical coupling of the exhaust-gas recirculation valve to the throttle flap, the setpoint position of the exhaust-gas recirculation valve already yields the setpoint position of the throttle flap, and vice versa. If the setpoint position of the exhaust-gas recirculation valve is determined by means of the above equation (1), then the setpoint position of the throttle flap is thus already defined. Since, however, in the case of throttling on the fresh-air side, a variation of the position of the throttle flap generally causes the gas pressure downstream of the throttle flap to also be varied, a new value for the gas state e_{nachEGR} results. This type of activation therefore generally leads to an undesired, unstable activation behavior, because e_{nachEGR} is dependent on s_{EGR}. In principle, it would be necessary to determine s_{EGR,SP} from the solution to the equation

$${s}_{EGR , SP} = {A}_{EGR}^{- 1} ( \frac{{\dot{m}}_{EGR , SP}}{{g}_{EGR} ( {e}_{vor EGR} , {e}_{nach EGR} ( {s}_{EGR , SP} ) )} ) . \qquad ( 3 )$$

Here, the dependency of e_{nachEGR}(s_{EGR,SP}) is given by the equations

\dot{m}_{THR}=A_{THR}(s_{THR})·gₜₕᵣ(e_{vorTHR},e_{nachTHR}) and

s_{THR}=s_{EGR}.

Here,

\dot{m}_{THR} is the gas mass flow through the throttle flap,

A_{THR} is the effective opening cross section of the throttle flap,
s_{THR} is the position of the throttle flap, and
s_{EGR} is the position of the exhaust-gas recirculation valve.

Since the implicit equation (3) cannot be rearranged into an explicit equation for the setpoint position, a cumbersome iterative solution procedure would be necessary in order to solve the equation (3) and thus determine the setpoint position. To avoid this, the following relationship is utilized: In the case of an only small degree of opening of the exhaust-gas recirculation valve, the throttle flap is either not closed at all or is closed only to a very small degree. The small degree of opening of the exhaust-gas recirculation valve leads to a large change in the recirculated exhaust-gas mass flow. The small degree of closure of the throttle flap leads to only a small change, or no change at all, in the gas pressure downstream of the throttle point. The determination of the setpoint position for the exhaust-gas recirculation valve by means of the stated equation (1) is thus stable.

In the case of the exhaust-gas recirculation valve being opened to a very great extent, the change in the geometrical cross-sectional area of the exhaust-gas recirculation valve alone does not result in a significant change in mass flow. By contrast, as a result of the mechanical coupling of the exhaust-gas recirculation valve to the throttle flap, the throttle flap is almost closed, which leads to an intense change in the pressure downstream of the throttle point. In the case of throttling on the exhaust-gas side, as illustrated in FIG. 1, this intense change in the pressure occurs upstream of the throttle point. An adjustment of the recirculated exhaust-gas mass flow is realized in this case by means of a variation of the opening position of the throttle flap, and not by means of a variation of the opening position of the exhaust-gas recirculation valve.

The effective opening cross-sectional area of the exhaust-gas recirculation valve and of the throttle flap as a function of the joint position or setting of the valve will be illustrated below.

FIG. 3 shows a diagram for illustrating the effective opening cross-sectional area 01 of the exhaust-gas recirculation valve as a function of the opening position P of the exhaust-gas recirculation valve.

FIG. 4 shows a diagram for illustrating the effective opening cross-sectional area 02 of the throttle flap, which is mechanically coupled to the exhaust-gas recirculation valve, as a function of the opening position P of the exhaust-gas recirculation valve. It is clear that, when the exhaust-gas recirculation valve is closed, the throttle flap is open, and vice versa.

Now, the pressure setpoint value in e_{nach THR,SP} from equation (2) will be determined by means of the relationship

\dot{m}_{EGR,SP}=A_{EGR}(s_{EGR,SP})g_{EGR}(e_{vor EGR},e_{nach EGR}) (4)

by solving for e_{nachEGR}. In the case of throttling on the fresh-air side, as shown in FIG. 2, the pressure downstream of the throttle flap is substantially identical to the pressure downstream of the exhaust-gas recirculation valve. It is however now the case here that the function A_{EGR}(s_{EGR,SP}) is replaced by a constant cross-sectional area A_{EGR,p-controlled}, which is selected to be slightly smaller than the maximum cross-sectional area of the exhaust-gas recirculation valve and which is optionally determined in a manner dependent on the engine operating point. A pressure thus determined in e_{nachTHR,SP} is now utilized to determine s_{THR,SP} in accordance with equation (2). At the same time, the setpoint value for the position of the exhaust-gas recirculation valve is determined using equation (1). The actually applicable setpoint value for the joint position of exhaust-gas recirculation valve and throttle flap will however now be determined by means of the maximum of the setpoint values s_{THR,SP} and s_{EGR,SP} thus calculated. A unique calculation rule for the joint position of exhaust-gas recirculation valve and throttle flap is thus defined, which has the following characteristics:

For a small recirculated setpoint mass flow, equation (1) yields a setpoint position with a cross-sectional area of the exhaust-gas recirculation valve smaller than A_{EGR,p-controlled}. The setpoint position for the throttle flap, which is determined by means of the pressure setpoint value downstream of the throttle and the exhaust-gas recirculation valve assuming a wide-open exhaust-gas recirculation valve A_{EGR,p-controlled}, is now lower than the setpoint position determined using equation (1). The system composed of exhaust-gas recirculation valve and throttle flap is in an operating range in which the mass flow across the exhaust-gas recirculation valve can be set substantially by means of the cross-sectional area of the exhaust-gas recirculation valve.

If, by contrast, for a relatively large recirculated setpoint mass flow, equation (1) yields a setpoint position which corresponds to a cross-sectional area larger than A_{EGR,p-controlled}, then the setpoint position determined using equation (2) will yield a higher setpoint position s_{THR,SP}, because a relatively small cross-sectional area A_{EGR,p-controlled} was indeed taken as a starting point for the pressure setpoint value determination. Thus, the mass flow across the exhaust-gas recirculation valve is now determined substantially by the required pressure drop across the throttle point.

With this method, the coupled system composed of throttle flap and exhaust-gas recirculation valve may be activated in a stable manner. Here, both flaps—the throttle flap and the exhaust-gas recirculation valve—are physically characterized in model-based fashion substantially independently of one another. A direct determination of the mass flow across the exhaust-gas recirculation valve is possible, and the activation is automatically adapted in the event of a variation of the setpoint value. This is may be used in particular in the case of different operating modes of the internal combustion engine.

In some embodiments, two different ranges are used in order to convert the setpoint mass flow for recirculation into a suitable valve position, specifically a mass flow activation range, in which the setpoint position is obtained directly from the model of the exhaust-gas recirculation valve (equation 1), and a pressure activation range, in which firstly a pressure setpoint value downstream of the exhaust-gas recirculation valve is determined on the basis of the model of the exhaust-gas recirculation valve according to equation 4, and then a setpoint position for the throttle flap is determined from the model of the throttle flap (equation 2). The required switch between these two ranges is performed by means of the above-described selection of the maximum of the cross-sectional area.

### LIST OF REFERENCE DESIGNATIONS

100 Internal combustion engine
110 Air filter
120 Turbocharger
125 Compressor
130 Exhaust-gas turbine
135 Charge-air cooler
140 Throttle
150 Cylinder
158 Catalytic converter
160 Particle filter
162 Exhaust-gas flap
164 Silencer
166 High-pressure exhaust-gas recirculation arrangement
168 Bypass flap
170 Cooler
172 High-pressure exhaust-gas recirculation valve
180 Low-pressure exhaust-gas recirculation arrangement
182 Throttle flap
184 Cooler
186 Low-pressure exhaust-gas recirculation valve
188 Control unit
se1, . . . , sen Sensor signals
s1, . . . , sn Control signals

What is claimed is:

1. A method for adjusting a mass flow through an exhaust-gas recirculation valve mechanically coupled to a throttle flap of an internal combustion engine which has a turbocharger, the method comprising:
determining a first setpoint value corresponding to a setpoint opening position of the exhaust-gas recirculation valve;
determining a second setpoint value corresponding to a setpoint opening position of the throttle flap;
comparing the first setpoint value to the second setpoint value;
adjusting the mass flow of the exhaust-gas recirculation valve varying an opening position of the exhaust-gas recirculation valve if the first setpoint value is higher than the second setpoint value; and
adjusting the mass flow of the exhaust-gas recirculation valve by varying an opening position of the throttle flap if the second setpoint value is higher than the first setpoint value.

2. The method as claimed in claim 1, wherein determining the first setpoint value depends a formula comprising:
$${s}_{EGR , SP} = {A}_{EGR}^{- 1} ( \frac{{\dot{m}}_{EGR , SP}}{{g}_{EGR} ( {e}_{vor EGR} , {e}_{nach EGR} )} ) ,$$
where s_{EGR,SP} is the setpoint position of the exhaust-gas recirculation valve, A_{EGR}⁻¹ is an inverse function for the effective opening cross section of the exhaust-gas recirculation valve, \dot{m}_{EGR,SP} is the setpoint mass flow through the exhaust-gas recirculation valve, and g_{EGR}(e_{vorEGR},e_{nachEGR}) is a function of the gas characteristics upstream and downstream of the exhaust-gas recirculation valve.

3. The method as claimed in claim 1, wherein determining the second setpoint value depends on a formula comprising:
$${s}_{THR , SP} = {A}_{THR}^{- 1} ( \frac{{\dot{m}}_{THR , SP}}{{g}_{THR} ( {e}_{vor THR} , {e}_{nach THR , SP} )} ) ,$$
where S_{THR,SP} is the setpoint position of the throttle flap, A_{THR}⁻¹ is an inverse function for the effective opening cross section of the throttle flap, \dot{m}_{THR,SP} is the setpoint mass flow through the throttle flap, and g_{THR}(e_{vorTHR}, e_{nachTHR}) is a function of the gas characteristics upstream and downstream of the throttle flap.

4. The method as claimed in claim 3, wherein determining the second setpoint value includes, firstly a pressure setpoint value is determined on the basis of the model of the exhaust-gas recirculation valve, and subsequently the setpoint position of the throttle flap is determined on the basis of the model of the throttle flap.

5. The method as claimed in claim 4, wherein determining the second setpoint value includes using, firstly the relationship
\dot{m}_{EGR,SP}=A_{EGR}(s_{EGR,SP})g_{EGR}(e_{vor EGR},e_{nach EGR})
to determine the pressure setpoint value downstream of the exhaust-gas recirculation valve, and secondly using the determined pressure setpoint value to determine the second setpoint value.

6. A device for controlling an internal combustion engine, the device comprising:
an exhaust-gas recirculation valve;
a throttle flap mechanically coupled to the exhaust-gas recirculation valve;
a turbocharger; and
a control unit programmed to adjust a mass flow through the exhaust-gas recirculation valve by:
determining a first setpoint value corresponding to a setpoint opening position of the exhaust-gas recirculation valve;
determining a second setpoint value corresponding to a setpoint opening position of the throttle flap;
comparing the first setpoint value to the second setpoint value;
adjusting the mass flow of the exhaust-gas recirculation valve by varying an opening position of the exhaust-gas recirculation valve if the first setpoint value is higher than the second setpoint value; and
adjusting the mass flow of the exhaust-gas recirculation valve by varying an opening position of the throttle flap if the second setpoint value is higher than the first setpoint value.
